(19) United States
(12) Patent Application Publication
(10) Pub. No.: US 2020/0323729 A1
(43) Pub. Date: Oct. 15, 2020

(54) WEARABLE MASSAGE DEVICE

(71) Applicants: Albert Arazi, Brooklyn, NY (US); Ching-Yi Tang, Brooklyn, NY (US)

(72) Inventors: Albert Arazi, Brooklyn, NY (US); Ching-Yi Tang, Brooklyn, NY (US)

(73) Assignee: Global Trading and Promotion, Inc., Brooklyn, NY (US)

(21) Appl. No.: 16/379,986

(22) Filed: Apr. 10, 2019

(51) Int. Cl. A61H 7/00; A61H 23/02

(52) U.S. Cl. CPC A61H 7/004; A61H 23/02; A61H 2201/1671; A61H 2201/1678; A61H 2201/1616; A61H 2205/04; A61H 2201/1652; A61H 2201/1645; A61H 2201/0192; A61H 2201/1207; A61H 2201/5025; A61H 2201/1626

(57) ABSTRACT

The present invention provides a wearable neck and shoulder massager device having a wearable assembly including: a front section, a rear section, an interior section located between the front and the rear sections, a top section connected to the top of the front and the rear sections, and a lower section connected to the bottom of the front and the rear sections. A right upper shoulder support member and a left upper shoulder support member are connected to the top section of the wearable neck massager. The structure also includes a plurality of massage heads affixed to the front section of the neck massager for massaging the back of the neck and/or shoulders of the wearer. Also, a motor and controller are connected to a power source located within the interior section of the wearable neck massager, wherein the motor causes vibrational, rotational, and/or oscillating movement of the massage heads for massaging the back of the neck and/or shoulders of the wearer.

### FIELD OF THE INVENTION

The present invention relates to a hands-free, wearable neck and shoulder massager device worn like a posture corrector, and includes a back support connected to the massager device for adjusting and tightly positioning the massager device on the wearer's neck and shoulders, so that the wearer can receive a neck and/or shoulder massage without having to use their hands to hold the massager device on the neck or shoulders.

### BACKGROUND OF THE INVENTION

Many people have jobs that require them to sit at desks or drive automobiles for long periods of time. These people often experience uncomfortable neck pain. Neck massage therapy is a therapeutic way to alleviate or relieve this neck pain or tension. Neck massages improve blood circulation, and help alleviate headaches and neck pain. In particular, using mechanical vibration type massage devices are very effective for treating neck and/or shoulder pain. Vibrational massage helps relieve painful conditions by creating numbness in the afflicted area and helps relax neck and/or shoulder muscles surrounding the painful site, which can further reduce the pain. Using vibrational massage on the neck and/or shoulder region also provides the recipient with a sense of invigoration.

Effective vibrational massage is often performed by a therapist. However, this often entails setting up appointments and is often time consuming and expensive. To solve these problems, numerous electronic vibrational massage devices have been marketed to permit people to actually massage themselves. However, it is often difficult for people to reach the back of their neck and/or shoulders with hand held electronic massage devices in order to provide an effective vibrational massage to this area. Thus, it would be a benefit to have an electronic self-massaging device that includes a massaging mechanism for allowing a wearer to easily position massaging units directly onto their neck and/or shoulder region while holding the unit directly in place on their neck and/or shoulders without the use of the wearer's hands and arms.

Accordingly, there is a need for an electronic massager device featuring a back support and straps that tightly position the device close to the back of the neck and/or shoulders of the wearer, which permits the wearer to receive a neck and/or shoulder massage without having to use their hands or arms to hold the massager device on their neck and/or shoulders, and which also improves their posture.

### DESCRIPTION OF THE PRIOR ART

Numerous prior art patents and patent applications disclose electronic neck and back massagers including straps and/or vest or backpack units that permit the wearers to administer self, hands-free massages to their neck and backs. The following patents disclose structural and ornamental designs for electronic neck and back massagers including straps and/or vest or backpack units that permit the wearers to administer self, hands-free massages to their neck, backs, and/or shoulders: (a) U.S. Design Pat. No. D389,584 to Robert D. Leventhal, et al. entitled “Combined Neck and Shoulder Massager” which issued on Jan. 20, 1998 discloses the ornamental design for a combined electronic neck and shoulder massager with straps; (b) U.S. Pat. No. 6,193,678 to Sammy S. Brannon entitled “Massaging System” which issued on Feb. 27, 2001 discloses a vest type massaging system that includes a mechanism for positioning and holding vibrating and heating units onto the body at wearer selected locations; (c) U.S. Pat. No. 6,626,341 to Carter Mitchell entitled “Massaging Book Bag” which issued on Sep. 30, 2003 discloses a massaging backpack having at least one shoulder strap for massaging an individual's shoulder area; (d) U.S. Pat. No. 7,207,953 to Irene Goicaj entitled “Massage Therapy Vest” which issued on Apr. 24, 2007 discloses a massage vest having a plurality of mechanical members attached thereto and wherein the vest is secured to the wearer with upper and lower straps that are affixed to the body of the vest; (e) U.S. Pat. No. 8,783,537 to Romina Ghassemi entitled “Ergonomic Backpack” which issued on Jul. 22, 2014 discloses a backpack for wearing on a back of a wearer including at least one cargo compartment, two straps, and a frame and wherein massaging beads are located in the frame and massage muscles on each side of the wearer's spine; (f) U.S. Patent App. Pub. No. 2009/0118652 to Vito James Carlucci entitled “Neck Massaging Device” was published on May 7, 2009 and discloses a u-shaped, electronic portable neck massaging appliance.

Also, the following products being sold on the Internet disclose neck massager devices with straps for securing the massager device to the wearer's back and neck: (a) the “HoMedics Cordless 3D TruTouch Neck & Shoulder Massager with Heat” being sold on www.brookstone.com; (b) the “Shiatsu Neck & Back Massager with Heat—VIKTOR JURGEN Deep Tissue Kneading Sports Recovery Massagers for Neck, Back, Shoulders, Foot” being sold on www.amazon.com; and (c) the “SunlitLife Cordless 12 nodes Shiatsu Neck Shoulder Back Electric Massager with Longer Straps. Rechargeable Use Shiatsu Neck & Back Belt Massager with Heat” also being sold on www.amazon.com.

Thus, none of the aforementioned prior art references teach or disclose the basic structure of a hands-free, wearable neck and shoulder massager device with straps for tightly securing the massager device to the wearer's back and neck. More specifically, none of the aforementioned prior art references teach or disclose a massager device featuring a back support connected to the massager device for adjusting and tightly positioning the upper neck portion of the massager device in close contact with the wearer's neck and/or shoulders, so that the wearer can receive an effective neck and/or shoulder massage without having to use their hands to hold the massager device on their neck and/or shoulders.

### OBJECTS OF THE INVENTION

It is an object of the present invention to provide a hands-free, wearable neck and shoulder massager device having a back support connected to the massager device, and with straps for securing the massager device to the wearer's back and neck, wherein the wearer wears the massager device similar to wearing a posture corrector that overcomes the shortcomings of the prior art.

Another object of the present invention is to provide a hands-free, wearable neck and shoulder massager device having a back support connected to the massager device, and with straps for securing the massager device to the wearer's back and neck, wherein the wearer of the massager device receives neck and/or shoulder massage therapy.

Another object of the present invention is to provide a hands-free, wearable neck and shoulder massager device having a back support connected to the massager device which has a plurality of selectively controllable rolling or rotating mechanical members.

Another object of the present invention is to provide a hands-free, wearable neck and shoulder massager device featuring a back support connected to the massager device, wherein the back support and the adjustability of the straps permit the wearer to adjust and tightly position the upper neck portion of the massager device in close contact with the wearer's neck and/or shoulders, so that the wearer can receive an effective neck and/or shoulder massage without having to use their hands to hold the massager device on their neck and/or shoulders.

Another object of the present invention is to provide a hands-free, wearable neck and shoulder massager device featuring a back support connected to the massager device, wherein the massager device has a controller for selectively setting the duration of the massage, the type of massage, and for otherwise controlling the rotating or rolling massage nodules.

Another object of the present invention is to provide a hands-free, wearable neck and shoulder massager device featuring a back support connected to the massager device, and with straps for securing the massager device to the wearer's back and neck, wherein the massager device has a rechargeable battery pack.

Another object of the present invention is to provide a hands-free, wearable neck and shoulder massager device featuring a back support connected to the massager device, and with straps for securing the massager device to the wearer's back and neck, wherein the massager device is readily portable and can be easily carried by the wearer.

### SUMMARY OF THE INVENTION

The present invention provides a wearable neck and shoulder massager device having a wearable assembly including: a front section, a rear section, an interior section located between the front and the rear sections, a top section connected to the top of the front and the rear sections, and a lower section connected to the bottom of the front and the rear sections. A right upper shoulder support member and a left upper shoulder support member are connected to the top section of the wearable neck and shoulder massager. The structure also includes a plurality of massage heads affixed to the front section of the neck and shoulder massager for massaging the back of the neck and/or shoulders of the wearer. Also, a motor and controller are connected to a power source located within the interior section of the wearable neck and shoulder massager, wherein the motor causes vibrational, rotational, and/or oscillating movement of the massage heads for massaging the back of the neck and/or shoulders of the wearer.

### BRIEF DESCRIPTION OF THE DRAWINGS

FIG. 1 is a perspective view of the wearable neck and shoulder massager device;

FIG. 2 is a front view thereof of the wearable neck and shoulder massager device;

FIG. 3 is a top view thereof of the wearable neck and shoulder massager device;

FIG. 4 is a bottom view thereof of the wearable neck and shoulder massager device;

FIG. 5 is a left side view thereof of the wearable neck and shoulder massager device;

FIG. 6 is a rear view thereof of the wearable neck and shoulder massager device shown being worn by a wearer wherein the massage heads are resting on both the neck and shoulders of the wearer in order to provide an effective massage to the wearer's neck and shoulders; and

FIG. 7 is a right side view thereof of the wearable neck and shoulder massager device shown being worn by a wearer.

### DETAILED DESCRIPTION OF THE PREFERRED EMBODIMENT

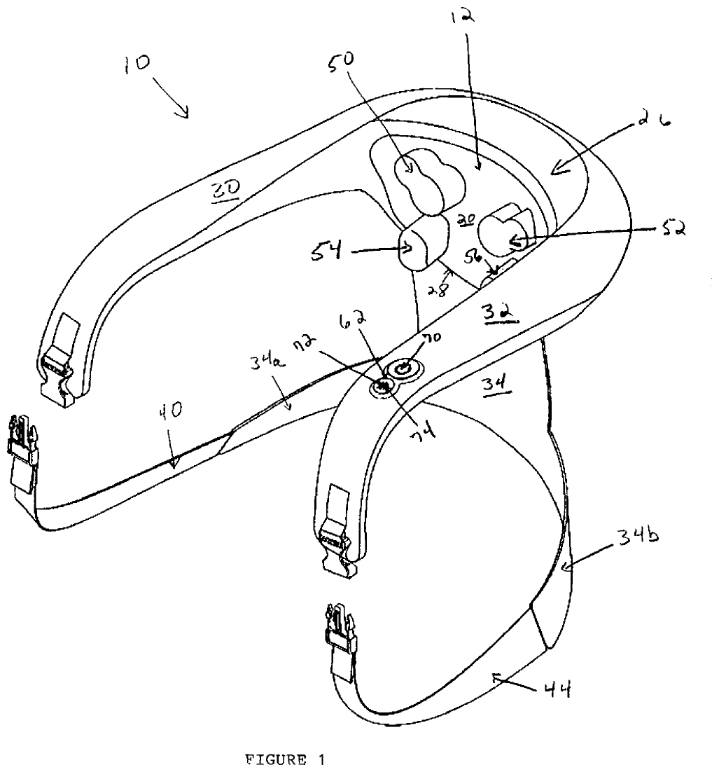

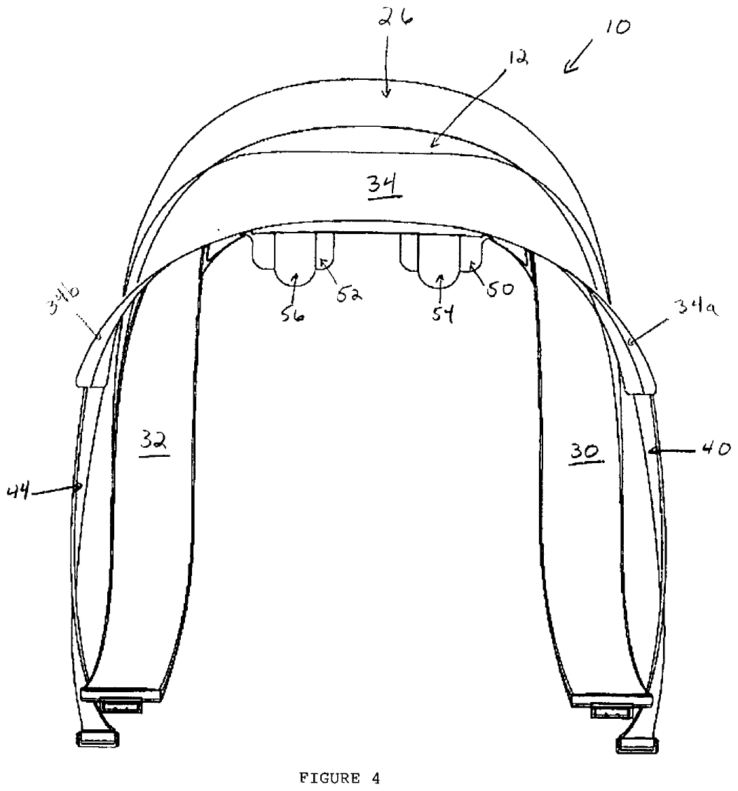

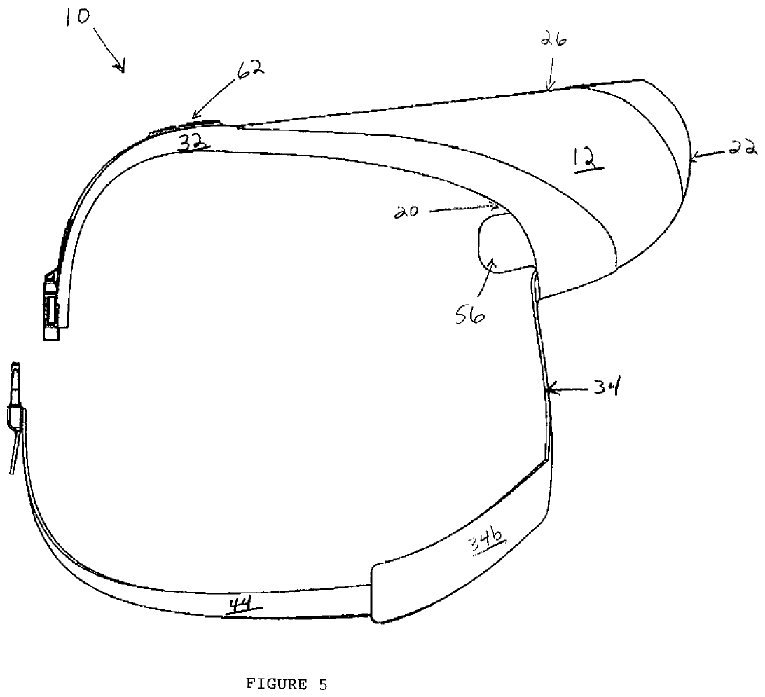

A wearable neck and shoulder massager device 10 is provided having a wearable assembly 12, as shown in FIGS. 1 through 7. The wearable assembly 12 includes: a front section 20, a rear section 22, an interior section 24 located between the front section 20 and the rear section 22, a top section 26 connected to the top of the front and the rear sections, and a lower section 28 connected to the bottom of the front and the rear sections. The wearable assembly 12 further includes: a right upper shoulder support member 30 connected to the top section 26 of the wearable assembly 12, a left upper shoulder support member 32 connected to the top section 26 of the wearable assembly 12, and a back support 34 connected to the lower section 28 of the wearable assembly 12 for engaging the wearer's back. The back support further has a right lower attachment portion 34a and a left lower attachment portion 34b. A lower right strap 40 is connected to the right lower attachment portion of the back support 34a and is also mateably engageable with the right upper shoulder support member 30. Also, a lower left strap 44 is connected to the left lower attachment portion of the back support 34b and is also mateably engageable with the left upper shoulder support member 32.

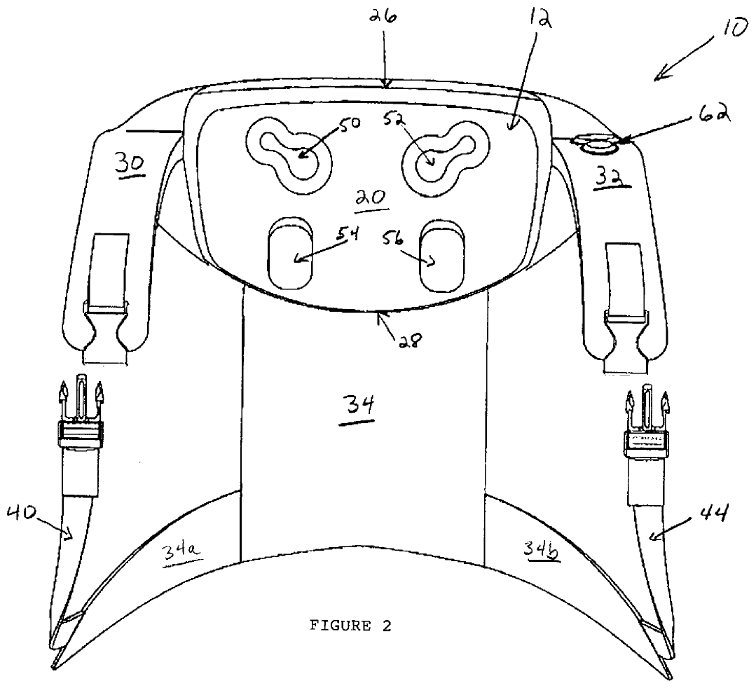

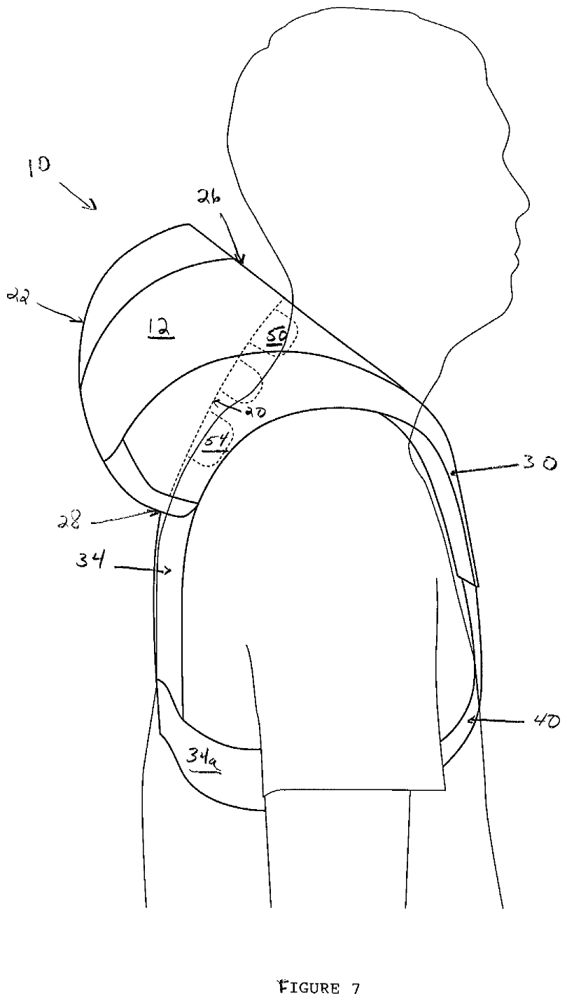

As shown in FIGS. 1 and 2, the right upper shoulder support member 30 and the left upper shoulder support member 32 are fully adjustable. Also, the lower right strap 40 and the lower left strap 44 are fully adjustable. Thus, when the lower right strap 40 is mateably engaged with the right upper shoulder support member 30 and when the lower left strap 44 is mateably engaged with the left upper shoulder support member 32, as shown in FIG. 7, the wearer can fully adjust the wearable neck massager device 10, so that it fits tightly onto their back and neck.

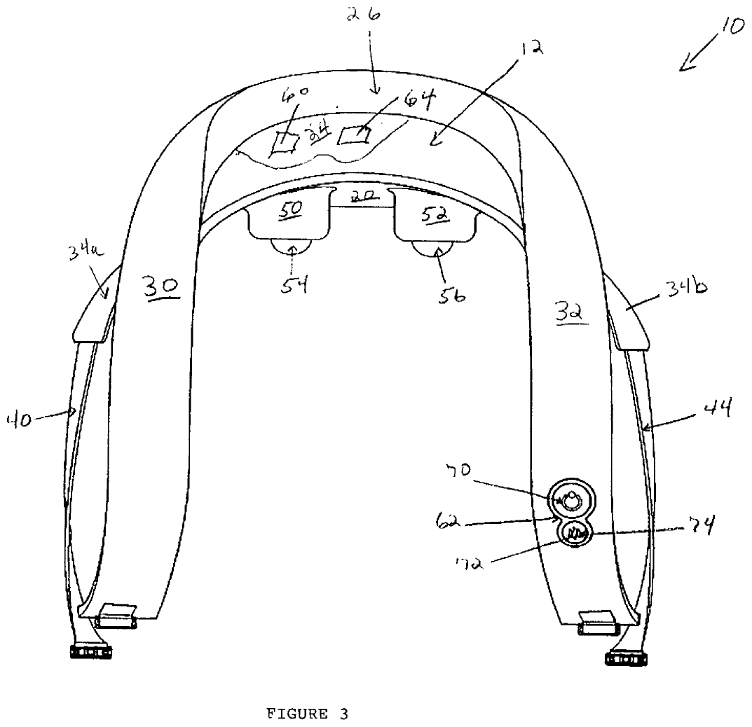

As shown in FIGS. 1 and 2, a plurality of massage heads 50, 52, 54, and 56 are affixed to the front section of the wearable assembly 12 for massaging the back of the neck and/or shoulders of the wearer. The massage heads 50, 52, 54, and 56 can be arranged in vertical or horizontal massage groups. As shown in FIG. 3, a motor 60 is connected to a power source 64 located within the interior section 24 of the wearable assembly 12, wherein the motor 60 causes vibrational, rotational, and/or oscillating movement of the massage heads 50, 52, 54, and 56 for massaging the back of the neck and/or shoulders of the wearer. Also, a controller 62 having a processor is electrically connected to the motor 60 for controlling the vibrational, rotational, and oscillating movement of the massage heads 50, 52, 54, and 56.

Preferably, the power source 64 includes at least one replaceable battery 66 or at least one rechargeable battery 68. Also, the rechargeable battery or batteries 66 can be connected to a power cord for recharging them. Controller 62 is externally positioned on the top front side of the right upper shoulder support member 30 or positioned on the top front side of the left upper shoulder support member 32 so that the controller 62 is easily controlled by the wearer with only one hand.

In addition, the back support 34, as shown in FIGS. 1, 2, 5, 6 and 7, provides important advantages to the present wearable neck massager device. In conventional neck massager devices that do not feature a back support, such as the “HoMedics Cordless 3D TruTouch Neck & Shoulder Massager with Heat,” the upper shoulder supports and lower straps are connected directly to the neck massager device. With this prior art structure, the lower straps rest underneath the wearer's arms and rest in the wearer's armpit region. As a result of such a structure, any movement of the wearer's arms causes the neck massager to move laterally or side to side, and to move away from the back of the neck and/or shoulders of the wearer. The wearer then needs to constantly adjust the position of their arms in order to move the neck massager back into position on the back of the neck and/or shoulders that needs massaging. This in turn leads to an inefficient massage of the neck region and/or shoulders.

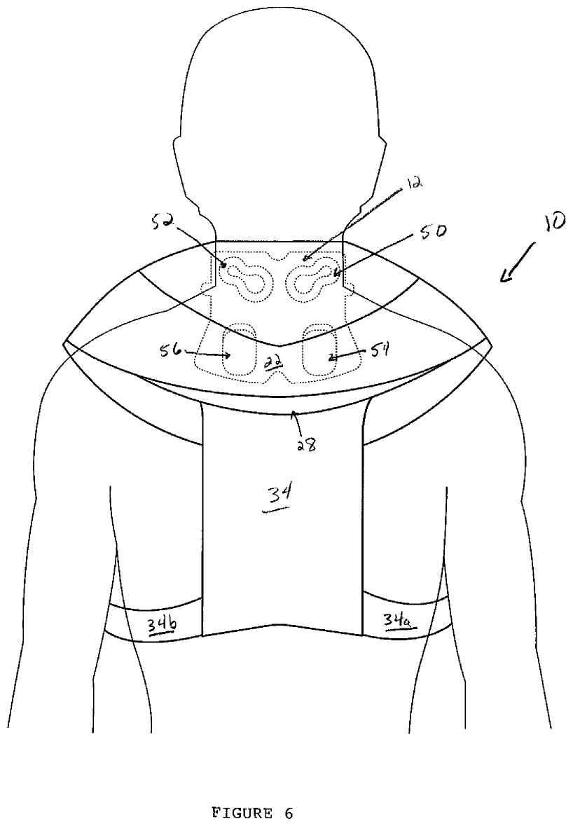

However, with the present invention, the back support 34 advantageously acts as a point of attachment for the lower right strap 40 and lower left strap 44, so that the lower straps do not rest underneath the wearer's arms, as shown in FIGS. 6 and 7. Thus, movement of the wearer's arms will not change the tight and close positioning of the massager device on the wearer's neck and/or shoulders. In this manner, the back support 34 acts as an anchor to permit the wearer to closely maintain the position of the neck massager on the neck and/or shoulders. Further, the right upper shoulder support member 30, the left upper shoulder support member 32, the lower right strap 40, and lower left strap 44, all cooperate to maintain the tight positioning on the neck, so that the plurality of massage heads 50, 52, 54, and 56 affixed to the front section of the wearable assembly 12 remain tightly positioned and forced in a downward direction into close contact with the back of the neck and/or shoulders of the wearer. This tight and close positioning of the massage heads 50, 52, 54, and 56 against the back of the neck and/or shoulders of the wearer ensures that the wearer receives an effective neck and/or shoulder massage without having to use their hands or arms to maintain the close contact of the massager device on the back of the neck and/or shoulders.

Also, the wearable neck massager device 10 of this invention may be constructed using a variety of materials, and by a variety of manufacturing methods.

The wearable assembly 12, right upper shoulder support member 30, the left upper shoulder support member 32, back support 34, lower right strap 40, and lower left strap 44 can be constructed of various materials which provide support. These materials can include elastic and inelastic fabrics. Elastic materials can include, but aren't limited to, any two-way orthopedic stretch fabric including but not limited to rubberized cloths and straps, synthetic polymer meshes such as Lycra and Spandex, elastic plastic materials, neoprene, vinyl, latex, and the like. Inelastic materials can include, but aren't limited to, canvas, cloth, polymer mesh and the like materials. For comfort and because of the discomforts associated with perspiration, it is preferred that the materials be porous to air and moisture whenever possible, such as by the use of open mesh materials on the wearable assembly 12 and back support 34.

Furthermore, the material used to construct the right and left upper shoulder support members 30, 32 can be filled with cushioning material for comfortably supporting and resting on the shoulders of a body. Likewise, the material used to construct the wearable assembly 12 and the back support 34 can also be filled with cushioning material for comfortably supporting and resting on the back of a body. The cushioning material used to fill the material used to construct the right and left upper shoulder support members 30, 32 and to fill the material used to construct the wearable assembly 12 and the back support 34 may be, but is not limited to, closed cell foam, open cell foam, memory foam, or a laminated foam/fabric combination.

In addition, anchor and/or attachment devices are used at various parts of the invention, including between the right upper shoulder support member 30 and the lower right strap 40 and between the left upper shoulder support member 32 and the lower left strap 44. These connections can be made by any of a variety of attachment devices, both removable and permanent, and therefore the invention need not be so limited. The specific examples given herein are intended as illustrative only, and include magnets, buckles, slip-lock buckles, Velcro, buttons, snaps and male/female releasable connections.

Where a fixed attachment is desired that is not readily detachable, a more permanent method can be used, included by stitch, staple, brad, screw, adhesive, and the like permanent attachment means. Particularly preferred is Velcro because of the flexibility in tension adjustment and because it accommodates adjustment made where only one hand is available.

### OPERATION

In operation, and as shown in FIGS. 1 through 7, a wearer places the wearable neck massager device 10 around his or her neck so that the right and left upper shoulder support members 30, 32 rest on the wearer's shoulders and the plurality of massage heads 50, 52, 54, and 56 on the front section of the wearable assembly 12 are in contact with the back of the wearer's neck and/or shoulders.

As shown in FIGS. 1, 2, 6 and 7, the wearer then attaches the lower right strap 40 to the right upper shoulder support member 30 so that the lower right strap 40 and right upper shoulder support member 30 form a loop around the wearer's right arm. In a similar fashion, the wearer also attaches the lower left strap 44 to the left upper shoulder support member 32 so that the lower left strap 44 and left upper shoulder support member 32 form a loop around the wearer's left arm.

The wearer then adjusts the right and left upper shoulder support members 30, 32 and the right and left lower straps 40, 44 so that the wearable neck massager device 10 fits securely, tightly and comfortably on the wearer wherein the plurality of massage heads 50, 52, 54, and 56 tightly and comfortably are resting on the back of the wearer's neck and/or shoulders. As previously stated, because the back support 34 acts as a point of attachment for the lower straps 40 and 44, the back support 34 acts as an anchor to permit the wearer to closely maintain the position of the neck massager on the neck and/or shoulders. Further, the upper shoulder support members 30 and 32, and the lower straps 40 and 44, all cooperate to maintain the tight positioning on the neck, so that the plurality of massage heads 50, 52, 54, and 56 remain tightly positioned and forced in a downward direction into close contact with the back of the neck and/or shoulders of the wearer. This tight and close positioning of the massage heads 50, 52, 54, and 56 against the back of the neck and/or shoulders of the wearer ensures that the wearer receives an effective neck massage without having to use their hands or arms to maintain the close contact of the massager device on the back of the neck and/or shoulders.

As shown in FIGS. 1 and 3, the wearer activates the power with the on/off button 70 on the controller 62 and uses the other mode buttons 72, 74 to control hi/low or type of massaging functions, e.g., vibrational, rotational, and/or oscillating movement of the massage heads 50, 52, 54, and 56. The electronic circuitry for controlling the motor 60 are of a type generally known. Generally, when the motor 60 is activated from an “off” condition to an “on” condition by the controller, the motor 60 causes the massage heads 50, 52, 54, and 56 to be driven in a vibrational, rotational, and/or oscillating fashion. The motor 60 also has two separate operating speeds that cause the massage heads 50, 52, 54, and 56 to rotate together at the two separate speeds, respectively. In this manner, the massage heads 50, 52, 54, and 56 effectively impart massaging rotational and axial forces to the neck and/or shoulders of the wearer.

In the specification the terms “comprise, comprises, comprised and comprising” or any variation thereof and the terms “include, includes, included and including” or any variation thereof are considered to be totally interchangeable and they should all be afforded the widest possible interpretation.

The foregoing specification, including the specific embodiments and examples, is intended to be illustrative of the present invention and is not to be taken as limiting. Numerous other variations and modifications can be effected without departing from the true spirit and scope of the invention.

### Advantages of the Present Invention

It is an advantage of the present invention to provide a hands-free, wearable neck and shoulder massager device having a back support connected to the massager device, and with straps for securing the massager device to the wearer's back and neck, wherein the wearer wears the massager device similar to wearing a posture corrector that overcomes the shortcomings of the prior art.

Another advantage of the present invention is to provide a hands-free, wearable neck and shoulder massager device having a back support connected to the massager device, and with straps for securing the massager device to the wearer's back and neck, wherein the wearer of the massager device receives neck and/or shoulder massage therapy.

Another advantage of the present invention is to provide a hands-free, wearable neck and shoulder massager device having a back support connected to the massager device which has a plurality of selectively controllable rolling or rotating mechanical members.

Another advantage of the present invention is to provide a hands-free, wearable neck and shoulder massager device featuring a back support connected to the massager device, wherein the back support and the adjustability of the straps permit the wearer to adjust and tightly position the upper neck portion of the massager device in close contact with the wearer's neck and/or shoulders, so that the wearer can receive an effective neck and/or shoulder massage without having to use their hands to hold the massager device on their neck and/or shoulders.

Another advantage of the present invention is to provide a hands-free, wearable neck and shoulder massager device featuring a back support connected to the massager device, wherein the massager device has a controller for selectively setting the duration of the massage, the type of massage, and for otherwise controlling the rotating or rolling massage nodules.

Another advantage of the present invention is to provide a hands-free, wearable neck and shoulder massager device featuring a back support connected to the massager device, and with straps for securing the massager device to the wearer's back and neck, wherein the massager device has a rechargeable battery pack.

Another advantage of the present invention is to provide a hands-free, wearable neck and shoulder massager device featuring a back support connected to the massager device, and with straps for securing the massager device to the wearer's back and neck, wherein the massager device is readily portable and can be easily carried by the wearer.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A wearable neck and shoulder massager device, comprising:
(a) a wearable assembly having a front section, a rear section, an interior section located between said front and said rear sections, a top section connected to the top of said front and said rear sections, and a lower section connected to the bottom of said front and said rear sections,
(b) a right upper shoulder support member connected to said top section of said wearable assembly,
(c) a left upper shoulder support member connected to said top section of said wearable assembly,
(d) a back support connected to said lower section of said wearable assembly for engaging the wearer's back,
(e) a lower right strap connected to said back support that is mateably engageable with said right upper shoulder support member,
(f) a lower left strap connected to said back support that is mateably engageable with said left upper shoulder support member,
(g) a plurality of massage heads affixed to said front section of said wearable assembly for massaging the back of the neck and shoulders of the wearer,
(h) a motor connected to a power source, wherein said motor causes, rotational, oscillating, or vibrational movement of said massage heads for massaging the back of the neck or shoulders of the wearer, and
(i) a controller having a processor electrically connected to said motor for controlling said rotational, oscillating, or vibrational movement of said massage heads.

2) A wearable neck and shoulder massager device according to claim 1, wherein said right and left upper shoulder support members are adjustable.

3) A wearable neck and shoulder massager device according to claim 1, wherein said right and left upper shoulder support members include cushioning material for supporting the shoulders of a body.

4) A wearable neck and shoulder massager device according to claim 1, wherein said wearable assembly includes cushioning material for supporting the back of a body.

5) A wearable neck and shoulder massager device according to claim 1, wherein said back support assembly includes cushioning material for supporting the back of a body.

6) A wearable neck and shoulder massager device according to claim 1, wherein said lower right and left straps are adjustable.

7) A wearable neck and shoulder massager device according to claim 1, further including attachment mechanisms selected from the group consisting of: magnets, buckles, slip-lock buckles, Velcro, buttons, snaps and male/female releasable connections; wherein said right and left upper shoulder support members mateably engage with said lower right and left straps by said attachment mechanisms.

8) A wearable neck and shoulder massager device according to claim 1, wherein said plurality of massage heads are arranged in vertical or horizontal massage groups.

9) A wearable neck and shoulder massager device according to claim 1, wherein said power source comprises at least one replaceable battery or at least one rechargeable battery.

10) A wearable neck and shoulder massager device according to claim 9, wherein said at least one rechargeable battery is connected to a power cord for recharging said rechargeable battery.

11) A wearable neck and shoulder massager device according to claim 1, wherein said controller is externally positioned on said right upper shoulder support member or on said left upper shoulder support member so that said controller is controlled by the wearer with only one hand.

12) A wearable neck and shoulder massager device according to claim 1, wherein said motor is operable between an on/off mode and two separate operating speeds that cause said massage heads to rotate together at the two separate speeds, respectively.

13) A wearable neck or shoulder massager device, comprising:
(a) a wearable assembly having a front section, a rear section, an interior section located between said front and said rear sections, a top section connected to the top of said front and said rear sections, and a lower section connected to the bottom of said front and said rear sections,
(b) a right upper shoulder support member connected to said top section of said wearable assembly,
(c) a left upper shoulder support member connected to said top section of said wearable assembly,
(d) a back support connected to said lower section of said wearable assembly for engaging the wearer's back,
(e) a lower right strap connected to said back support that is mateably engageable with said right upper shoulder support member,
(f) a lower left strap connected to said back support that is mateably engageable with said left upper shoulder support member,
(g) a plurality of massage heads affixed to said front section of said wearable assembly for massaging the back of the neck or shoulders of the wearer,
(h) a motor connected to a power source, wherein said motor causes, rotational, oscillating, or vibrational movement of said massage heads for massaging the back of the neck or shoulders of the wearer, and
(i) a controller having a processor electrically connected to said motor for controlling said rotational, oscillating, or vibrational movement of said massage heads.
